(19) United States
(12) Patent Application Publication
(10) Pub. No.: US 2003/0163691 A1
(43) Pub. Date: Aug. 28, 2003

(54) System and method for authenticating sessions and other transactions

(76) Inventor: Ted Christian Johnson, Issapuah, WA (US)

Correspondence Address: HEWLETT-PACKARD COMPANY, Intellectual Property Administration, P.O. Box 272400, Fort Collins, CO, 80527-2400, US

(21) Appl. No.: 10/085,895

(22) Filed: Feb. 28, 2002

(51) Int. Cl. H04L 9/00

(52) U.S. Cl. 713/168

(57) ABSTRACT

The present invention is generally directed to a system and method for authenticating a transaction. In one embodiment, a method computes a message digest of a user ID, selects an index number, selects selecting an encryption key from a plurality of encryption keys using the index number, encrypts the message digest using the selected encryption key, and converts the encrypted message into an ASCII string. In another embodiment, a system is provided having components for performing these steps.

### BACKGROUND OF THE INVENTION

1. Field of the Invention

The present invention generally relates to computer-based authentication systems, and more particularly to a novel system and method for authenticating sessions and other transactions.

2. Discussion of the Related Art

As is known, a wide-variety of authentication systems and processes are used for a variety of environments to verify participants. For example, when a user logs into a computer, an authentication system enables the computer to verify the identity of the user. Similarly, when a user is sending messages across an open network, the authentication system helps the recipient verify that the message truly originated from the user (and not an impostor) and was not subsequently altered. In other environments, like entry into events, airplanes, restricted areas, credit card and other financial transactions, etc., authentication systems and processes are used to verify the identity of the user or entrant. These systems and processes may include the use and/or verification of personal identification through personal identification numbers, personal IDs, drivers' licenses, badges, and other means.

In the context of computer-based systems, certain computer-based authentication systems are based on use of passwords. In such systems, a user may enter a password and the computer compares the password with a stored list of passwords. The computer permits access if the user-supplied password matches the password stored at the system. The security of a password system is based on the premise that only the user knows his/her password. However, the password system must maintain a list of valid passwords on a storage disk that may possibly be copied or physically stolen.

To mitigate the threat of theft, an improvement of the password system is to compute a one-way function of the password and store only those values. A list of passwords operated on by a one-way function is less useful to a thief because the one-way function cannot be easily reversed to recover the original passwords. Unfortunately, these lists are vulnerable to dictionary attacks, in which an attacker systematically guesses common passwords and operates on the guessed passwords with the one-way function. The results may be compared to the list of passwords to determine if there are any matches. Dictionary attacks can be conducted very efficiently and comprehensively using computers.

Other authentication systems are implemented on distributed computer networks having multiple clients and servers. In this context, it is desirable for an authentication system to accommodate authentication between participants who communicate over a network. Typically, participant authentication is achieved through use of cryptographic public key systems. In such systems, each participant may have a unique private key that is kept secret and a corresponding public key that is published for all to know. The public/private key pair can be used to encrypt and decrypt messages bound for the participant, or to digitally sign messages on behalf of the participant, or to verify the participant's signature.

One conventional approach to a distributed authentication system is to encrypt each user's private key with that user's password and to store all encrypted keys at a centralized, publicly-accessible server. To retrieve the private key, the user simply enters a password on a client computer. The encrypted key is fetched from the server and decrypted with the password. This prior art system has significant drawbacks. First, a snoop (or hacker) can eavesdrop on the network and record the encrypted key as it is passed from the server to the client. The snoop can then perform an off-line process to try to decipher the encrypted key. If the encryption is successfully deciphered, then the snoop may later log on and be authenticated as the user.

To illustrate such a known system, reference is made to FIG. 1, which is a diagram illustrating the authentication process in a Web environment by a Web site 10 having multiple front-end Web servers 20, 30, and 40. As is known, as the traffic to Web sites increases, a plurality of Web servers are often utilized in order to avoid a slow-down or bottleneck in communications at the Web site. As is also known, communications with the Web site 10 are typically initiated by a transmission from a remote client 12. The communications between the client 12 and Web site 10 typically take place over a wide area network (e.g., the Internet—not specifically illustrated) using communication methods and protocols that are known and understood in the art.

In the illustrated environment, a session is initiated by a communication from the client 12 to a server 20 at the Web site 10. Assuming, for purposes of this example, that the first communication from the client 12 to the Web server 20 includes user identifying information, such as a user ID and password, then the Web server 20 will need to validate or authenticate the user's identification. Of course, if there is only a single Web server at the Web site, this validation or authentication may be done solely on the single machine of the Web server. However, in systems like that illustrated in FIG. 1, where a plurality of Web servers collaborate to provide a Web site, then an alternative method for authentication or validation must be provided.

In the illustrated embodiment, a separate authentication server 50 is provided. After the initial request by the client 12 to access the Web site 10, Web server 20 passes that request along to the authentication server, which performs the user authentication and generates a responsive message that is sent back to the Web server 20, which relays it on to the client 12. It will be appreciated that the communication from the Web server 20 to the client 12 is in the form of an HTTP response. This response typically includes information, either in the form of a cookie or otherwise, that provides certain session information, so that when the client 12 again tries to access the Web site 10, this information is communicated back to the Web site 10. This avoids the need for the user at the client 12 to have to repeatedly provide user ID and password information with each HTTP request sent to the Web site 10. Of course, login sequences may be required after a period of time of inactivity, if the Web site 10 terminated the session.

In keeping with the illustration of FIG. 1, assume that the user at the client 12 wishes to again access the Web site 10 (while the session is still active). Through mechanisms that are transparent to the user at the client station 12, subsequent HTTP requests may be communicated to a different Web server 30 than the previous request. With the subsequent request, however, the authentication information that was communicated from Web server 20 back to the client 12 at the initiation of the session are included in the subsequent request. In this regard, the browser running at the client station 12 may extract and pass along information from a cookie stored at the client 12 along with the HTPP request. This information is then communicated from Web server 30 to the authentication server 50, which verifies the authentication of the user and session, and generates an appropriate reply back to the Web server 30. The Web server 30, upon receiving this validation, may generate an HTTP response (that is responsive to the user's current HTTP request) and respond accordingly to the client station 12.

There are several known drawbacks to prior art systems such as these. One drawback relates to the additional communications between the various front-end Web servers 20, 30, and 40 and the back-end authentication server 50. Another drawback relates to the additional equipment required in the form of the authentication server 50, including software, maintenance, etc. Perhaps the most significant drawback, however, is that systems such as that illustrated in FIG. 1 have a single point of failure. Specifically, if the authentication server 50 crashes or is otherwise unavailable, then no session authentication or validation may take place, effectively bringing down the entire Web site 10 from access to remote users.

An alternative approach, which is not specifically illustrated, would be to have the Web server 20 validate the user's identification and then communicate the authentication and session information (e.g., session state) to the remaining Web servers that comprise the Web site. A drawback to this type of system relates to the added complexity and communication between the plurality of Web servers, in order to maintain synchronization of the various current sessions.

### SUMMARY OF THE INVENTION

Accordingly, there is a desire to provide an improved system and method for authenticating sessions and other types of transactions.

To achieve certain advantages and novel features, the present invention is generally directed to a system and method for authenticating a transaction. In one embodiment, a method computes a message digest of a user ID, selects an index number, selects an encryption key from a plurality of encryption keys using the index number, encrypts the message digest using the selected encryption key, and converts the encrypted message into an ASCII string. In another embodiment, a system is provided having components for performing these steps.

In another embodiment, a method receives a user ID, computes a message digest of the user ID, computes an expiration timestamp for the session, selects an index number, combines the message digest and expiration timestamp, accesses an encryption key using the index number, encrypts the combined message using the accessed encryption key, and converts the encrypted message into an ASCII string. In another embodiment, a system is provided having components for performing these steps.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating the communication in a prior art system between a remote client workstation and a Web site;

FIG. 2 is a diagram illustrating the communication between a remote client workstation and a Web site in accordance with an embodiment of the invention;

FIG. 3 is a flowchart illustrating the top-level operation of a method constructed in accordance with one embodiment of the invention;

FIGS. 4A-4F are diagrams illustrating various components and stages of the development of an authentication ticket of one inventive embodiment;

FIG. 5 is a diagram illustrating certain components of a system constructed in accordance with one embodiment of the present invention;

FIG. 6 is a flowchart illustrating the top-level operation of a method constructed in accordance with one embodiment of the invention;

FIG. 7 is a diagram illustrating certain components of a system constructed in accordance with one embodiment of the present invention;

FIG. 8 is a diagram illustrating certain components of a system constructed in accordance with one embodiment of the present invention; and

FIG. 9 is a diagram illustrating certain components of a system constructed in accordance with another embodiment of the present invention.

### DETAILED DESCRIPTION OF THE CERTAIN EMBODIMENTS

Having summarized various aspects of the present invention above, reference will now be made in detail to certain embodiments of the present invention. In this regard, the present invention provides a unique solution for authenticating sessions and other transactions. In the case of session authentication, an illustrated embodiment depicts an system and method for authentication of a session over the Web. Further, and as will be appreciated from the disclosure herein, the authentication systems and methodologies of the present invention are applicable to many other (i.e., non-Web) transactions as well.

Before describing various embodiments of the present invention, several definitions are set out immediately below. To the extent that these terms may have a particular meaning, as a term or art or otherwise, that differs from the definitions set out below, the definitions shall control the interpretation and meaning of the terms as used within the specification and claims herein, unless the specification or claims expressly assigns a differing or more limited meaning to a term in a particular location or for a particular application.

HyperText Transfer Protocol (HTTP) refers to an application-level protocol for distributed, collaborative, hypermedia information systems. It is a generic, stateless, object-oriented protocol which can be used for many tasks, such as name servers and distributed object management systems, through extension of its request methods.

Hypertext Markup Language (HTML) refers to a markup language for hypertext that is used with World Wide Web client browsers. Examples of uses of HTML are: publishing online documents with headings, text, tables, lists, photos, etc., retrieving online information via hypertext links, designing forms for conducting transactions with remote services (for use in searching for information, making reservations, ordering products, etc.), and including spreadsheets, video clips, sound clips, and other applications directly in documents.

Transmission Control Protocol (TCP) refers to a library of routines that applications can use when they need reliable network communications with another computer. TCP is responsible for verifying the correct delivery of data from client to server. It adds support to detect errors or lost data and to trigger reconstruction until the data is correctly and completely received.

Internet Protocol (IP) refers to a library of routines that TCP calls on, but which is also available to applications that do not use TCP. IP is responsible for transporting packets of data from node to node. It forwards each packet based on a destination address (the IP number).

Cookie refers to a tool used to maintain state variables concerning the World Wide Web. A cookie can take the form of an HTTP header that consists of a string of information about the visit that is entered into the memory of the browser. This string may contain the domain, path, lifetime, and value of a variable, among other type of information.

Uniform Resource Locator (URL) refers to a standard that was developed to specify the location of a resource available electronically. Examples of protocols that use URLs are HTTP, File Transfer Protocol (FTP), Gopher, Telnet sessions to remote hosts on the Internet, and Internet e-mail addresses. The Uniform Resource Locator describes the location and access method of a resource on the Internet, for example, the URL http://www.hp.com describes the type of access method being used (http) and the server location which hosts the Web site (www.hp.com).

Common Gateway Interface (CGI) refers to a standard for interfacing external applications with information servers, such as HTTP or Web servers. A plain HTML document that a Web daemon retrieves is static, which means it exists in a constant state. An example of this is a text file. A CGI program, on the other hand, is executed in real-time, so that it can output dynamic information. An example of the use of such a gateway is when a database is hooked up to the World Wide Web. In this case, a CGI program, which the Web daemon will execute to transmit information to the database engine, receives results back and display them to the client, needs to be created.

The foregoing definitions and examples should be understood by persons skilled in the art and have been provided merely to provide guidance in understanding the description that follows, but should not be construed to impose strict construction limitations upon the claims.

As summarized above, the present invention is directed to a novel system and method for authenticating various transactions. One embodiment is directed to a system and method for authenticating and verifying sessions in a distributed computer environment. An exemplary distributed computer environment is the World Wide Web (WWW or Web). Before describing this embodiment of the invention, and for completeness, a brief discussion of the Web and Web transactions will first be provided.

As is known, then Web is the aggregate of autonomous, heterogeneous, distributed, collaborative, hypermedia information systems existing on the underlying global computer network known as the Internet. Since about 1990, the Web has served as the basis for the construction of a multitude of constituent information systems (“Web sites”), providing countless applications in areas ranging from content publishing to electronic commerce.

Current Web sites are implemented with server computers (“Web servers”) which are accessed over the Internet by client computers (“Web clients”) using the Hypertext Transfer Protocol (HTTP) or its encrypted form (HTTPS). There are many public documents describing various versions, features, and aspects of HTTP. Use of the term “HTTP” herein should be understood to encompass all such versions of HTTP in both its clear and encrypted forms.

A typical interaction between a Web client and a Web server includes several HTTP transactions. For example, when a user of the Web client desires to access a resource on a particular Web site, the user operates Web client software (generally referred to as a “browser”) and indicates a URL, which specifies the location of the resource on the Web. From the URL, the browser determines the IP address of the Web server for the site and establishes communication with the Web server program at that address. The browser then sends an HTTP request message to the Web server program, containing the URL as well as additional metadata and parameters concerning the request.

The Web server program, in turn, resolves the request according to the nature of the resource identified by the URL. This process may be as simple as fetching a static file, or as complicated as executing further application logic to dynamically produce a response. In either case, the resolution (called a “Web page”) is downloaded, along with additional metadata regarding the outcome of the transaction, in an HTTP response message from the Web server program to the browser. The browser interprets the HTTP response and typically renders and displays the page to the user.

In most Web sites, such pages are hypermedia (often authored in HTML), including embedded URL's referencing other pages. If the user selects such an embedded URL (a “hyperlink”), a new HTTP request is formulated and the process repeats. In this way, multiple interactions like these may occur over time to constitute a cohesive experience of the Web site by the user. Such a collection of consecutive, experientially cohesive interactions with a Web site is called a “session”.

As is known, the HTTP protocol is inherently “stateless,” which means that an HTTP request contains no information about the outcome of a prior request. Therefore, a Web server communicating with a client computer cannot rely on HTTP for maintaining authentication and/or state over a session (i.e., storing information relating to the user's identification and overall interaction with the server, such that the information can automatically be accessed by the server, as needed when handling subsequent user requests within the same session, without further user intervention). With regard to user authentication, a Web session normally begins with a login sequence, during which the user enters an authenticating usemame (or other identification) and password. It is extremely undesirable, however, to require the user to repeatedly input this data for each HTML request sent to the Web server.

Many Web sites are thus faced with the problem of maintaining such “session state” over HTTP, in order to provide a rich, personalized, seamless user experience. There are known techniques that resolve the problem of session state maintenance between a single Web client and single Web server. These include techniques for storing session state information at the Web client (called “client-side session state”), as well as techniques for storing session state information at the Web server with reference from the Web client (called “server-side session state”). It should be recognized that the term “session state” encompasses much more than merely authentication or verification information (e.g., client ID and password), but also includes additional information as well. Even though this relatively broad term is used herein, it will be appreciated that the discussion pertaining to this broad term, as set forth herein, is also applicable to authentication and verification information, which are encompassed by the term.

In client-side solutions, when the server program creates session state information in the process of handling an HTTP request, it provides the data to the browser for retention, as part of the HTTP response. The information is provided by the server program in such a manner that the browser will automatically provide it back to the server program in any subsequent HTTP request(s) whose server processing requires the information. In this way, the client “remembers and reminds” the server of the session state information it needs.

Client-side session state solutions are enabled using various techniques known in the art. Perhaps the most popular example is the use of HTTP cookies. Specifically, when the Web server desires to store state data client-side, it includes a named data element (the “cookie”) within the HTTP response for the Web page. This element contains the state data to be retained by the client. It also specifies the scope of the data in terms of its duration, path, and network domain. In turn, the client includes the cookie within each subsequent HTTP request that conforms to that scope, so that the state data can be accessed by the responding server each time from the cookie contained in the request.

Other known techniques for enabling client-side session state include hidden HTML form arguments and URL-embedded arguments (e.g. query strings). With these techniques, the Web page content is created and returned by the server such that certain hyperlinks within it are pre-loaded with the state data the server desires to store, such that the data will be included in the subsequent HTTP request made by the client should the user select the hyperlink. The responding Web server can then obtain the state data from the hidden HTML form argument or URL contained within the request.

Generally, however, the various client-side constructs suffer shortcomings relating to security, size, and/or performance. With regard to security, all of the client-side constructs are open to inspection and modification by nefarious clients, simply due to the fact that the data is exposed to the client for retention and transmission back to the server. With regard to size limitation, most of the client-side constructs are problematic when data to be stored exceeds a few kilobytes. For example, URLs have undefined size limits but in practice many Web clients, servers, and proxies expect them to be no more than one or two kilobytes in size. As another example, it is known that cookies are generally limited to a size of 4K bytes. The number of cookies themselves, and the total size of all cookies retained by a client, have similarly narrow limits. Finally, with regard to performance, the client-side constructs generally involve two-way exchange of state information across the Internet, which for large state data especially may entail undesirable delay.

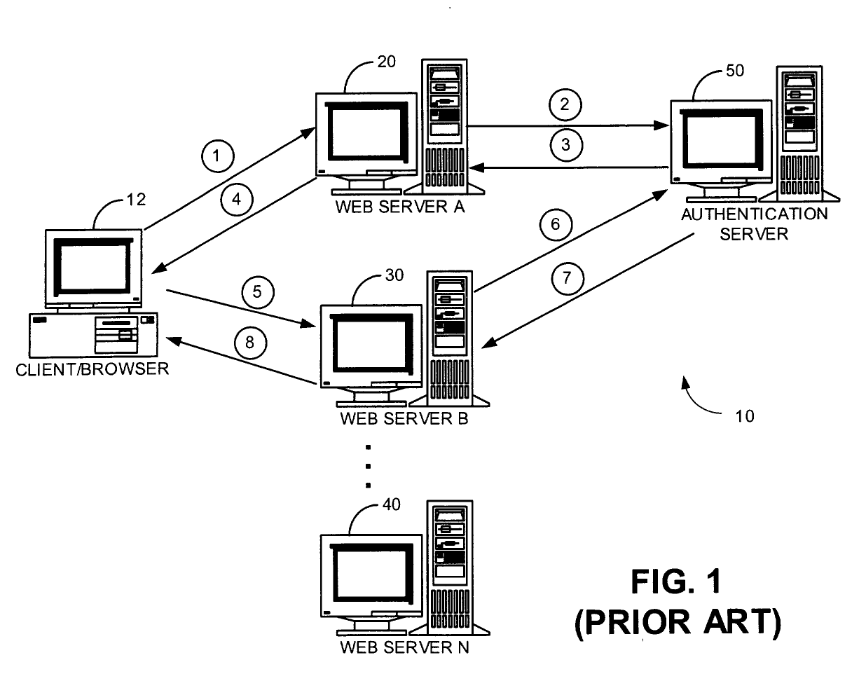

As the number of users increases, a typical Web site may not be able to handle all users' requests using a single server, but rather has to employ a pool of servers to handle user requests. Servers in such a pool are referred to as “collaborating,” and a simple example has been previously described in connection with FIG. 1.

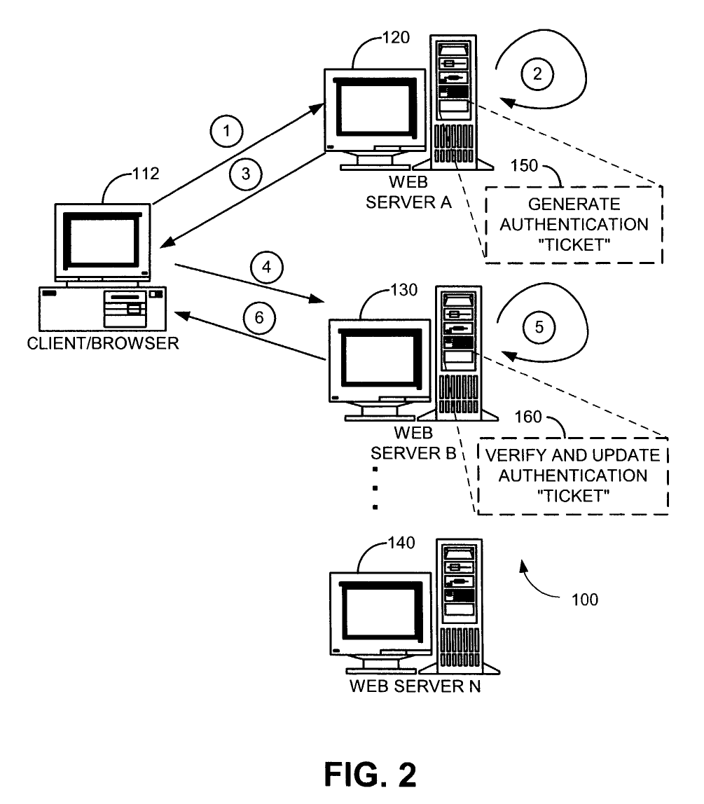

Having provided this general introduction to Web transactions and some of the associated limitations and considerations thereof, reference is now made to FIG. 2, which illustrates a session authentication process in accordance with one embodiment of the invention. In order to contrast the improvement of the present invention with the prior art, the embodiment illustrated in FIG. 2, like that of FIG. 1, includes a remote client 112 and a plurality of Web servers 120, 130, and 140, which Web servers collectively comprise the front end of a Web site 100. As will be described below, the unique methodology of the illustrated embodiment allows each of the Web servers 120, 130, and 140, to efficiently and independently authenticate a Web session without the need for synchronization among the Web servers 120, 130, and 140 and without the need for an additional authentication server.

Broadly, the authentication process implemented by the illustrated embodiment operates by generating a small authentication (or session) “ticket,” which is preferably a small payload of ASCII characters. In practice, a user at a client 112 submits an initial request to initiate a session at a Web site. This initial request may be directed to Web server 120 and include login information, such as user ID and password. Using one or more methodologies that are known, the system may initiate the session at the Web site. In addition, Web server 120 includes logic 150 for generating an authentication ticket. Of course, consistent with the scope and spirit of the invention, the logic 150 may be implemented in hardware, software, microcode, or a combination thereof. This authentication ticket (or session ticket) is then communicated back to the client 112 along with the HTTP response. Subsequent request from the client 112 to the Web site may include information from this authentication ticket. As will be described in more detail below, assuming that the Web session is still active, communication of this authentication information back to the Web site, through any of the Web servers 120, 130, or 140, will be effective to allow the user to continue operating within the established Web session.

In keeping with the illustration of FIG. 2, a later HTTP request may be communicated from the client 112 to Web server 130. Information from the authentication ticket previously generated by Web server 120 is communicated with this subsequent request and received by Web server 130. Web server 130, through a unique process, verifies the requesting user's ID with the authentication information, permitting the user to continue with the Web session in accordance with the permissions accorded to that user for the session. In one embodiment, Web server 130 will generate another authentication ticket, which is communicated back to the client 112 along with the HTTP response. This authentication verification and authentication information update may be performed by logic 160.

Significantly, in one embodiment, the authentication tickets are extremely compact, being only 18 bytes in one embodiment. Of course, consistent with the scope and spirit of the invention as will be further described herein, the actual size of the authentication ticket may vary from embodiment to embodiment. Another significant aspect of the illustrated embodiment is that the authentication ticket is provided in the form of an ASCII text string. Significantly, the communication of the authentication ticket in an ASCII string (as opposed to binary) is that it may be communicated back to a client 112 in the body portion (or potentially header portion) of an HTTP response, and will be properly interpreted by the browser running at the client workstation 112. In this regard, and as is known, many binary values may be difficult to communicate in an HTTP response, as they may be problematically interpreted by the browser. Further still, another significant advantage of the illustrated implementation is that the authentication ticket may be significantly encrypted (as described herein) so that decryption by would-be hackers is extremely difficult.

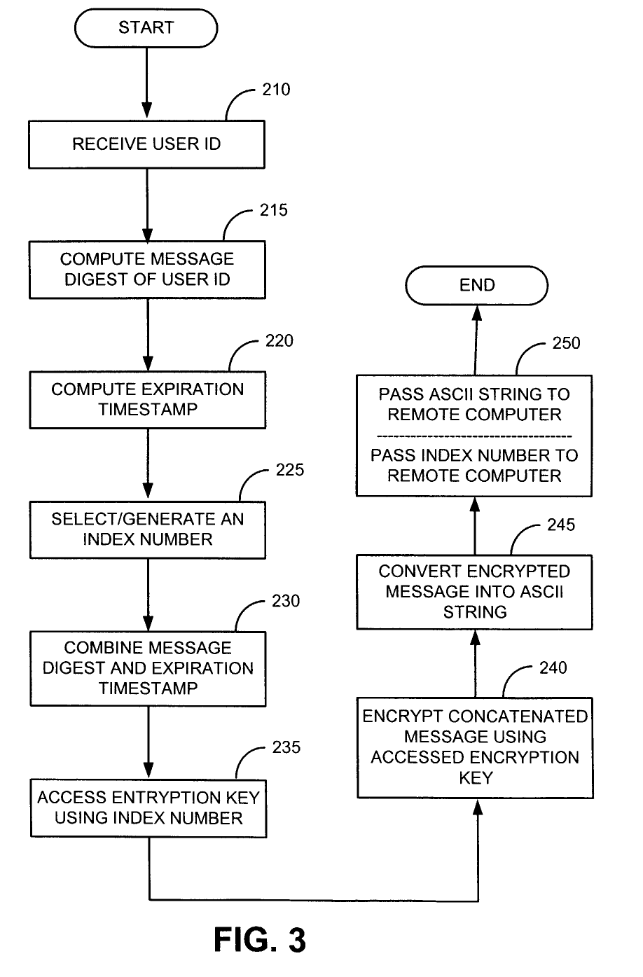

Reference is now made to FIG. 3, which is a flowchart illustrating the top-level functional operation of one embodiment of a logic block 150 (FIG. 2) that generates an authentication ticket in accordance with one embodiment of the invention. In the illustrated method, a user identification (or user ID) is received at a server (step 210). Typically, this user identification is extracted from an HTTP request that is communicated from a remote client. The client ID may take on a variety of forms, although it will typically be an alphanumeric character string. In addition, the client ID may be of any practical arbitrary length. Once the user ID is received, the method computes a message digest of the user ID (step 215). This message digest is simply a binary number that is representative of the user ID. In this regard, the message digest may be a simple checksum or other processed value. In the illustrated embodiment, the message digest is four bytes in length. Therefore, the system converts the user ID into a four-byte binary value. Thereafter, the method computes an expiration timestamp for the Web session (step 220).

As is known, a message digest (also known as a checksum, cyclic redundancy check, or hash) is simply a method or algorithm for representing a large amount of data is a relatively simply integer. Message digests are well known and need not be described herein. Indeed, popular message digests include MD5 (Message Digest 5) and SHA-1 (Secure Hash Algorithm-1). These or any of a variety of other algorithms may be implemented consistent with the scope and spirit of the invention.

As is known, most Web sites do not permit Web sessions to continue for indefinite periods of time. Otherwise, unless users go through an appropriate logout procedure, the session would stay active indefinitely, and never terminate. As more and more users access the site, this would result in an extremely large number of inactive sessions. Therefore, as a typical “house cleaning” measure, most Web sites place an expiration time on sessions. Normally this expiration time is updated or modified as a user continues to access a Web site in a single session. Therefore, the expiration timestamp comes into play when a user is inactive for a given period of time.

Although different methodologies and formats may be used for this timestamp, the illustrated embodiment utilized Epoch time notation, which is a number indicating the number of seconds that have elapsed since Jan. 1, 1970. Of course, other implementation details will necessarily be employed, such as adjusting for differing time zones, etc., but need not be discussed herein. In one embodiment, the expiration timestamp is a four-byte value.

The illustrated method then generates or selects an index number, which will be used to access an encryption key (step 225). The message digest (computed in step 215) and the timestamp are combined for encryption (step 230). In one embodiment, these values may be combined by a simple concatenation of the two values. However, in other embodiments, alternative method of combining the two values may be employed.

An encryption key is then accessed using the index number (step 235). In this regard, a local memory is preferably provided to store a plurality of encryption keys, which may be relatively lengthy. The index number may represent a location within the local memory from which the encryption key is retrieved. Since encryption methodologies are well known, they need not be described herein. However, it will be appreciated that a key is a value that is used in an algorithmic process for encrypting data. A decryption algorithm, which performs the inverse of the encryption algorithm, must know the encryption key in order to effectively decrypt the encrypted message. As is known, longer encryption keys provide for more robust encryption. Therefore, the system and method of the illustrated embodiment may implement a relatively robust encryption by selecting from only a limited number of encryption keys. In one embodiment, 256 encryption keys are provided, which may be selected from a single byte (i.e., 8 bit) index number.

It should be appreciated that the above-described methodology realizes improved security insofar as the encryption key itself is not passed over the network. Instead, only an index to the encryption key is passed. Since a would-be snoop or thief would not have the corresponding encryption keys, this index value will be of no value to the would-be snoop.

Once the encryption key is selected, the concatenated or otherwise combined message is encrypted using the access encryption key (step 240). Again, consistent with the scope and spirit of the invention, any of a variety of a known encryption methodologies or algorithms may be employed to perform this step. Thereafter, the encrypted message is encoded to an ASCII string (step 245). This may be performed using a simple “printf(3)” command, using a standard C language library call. Of course, other equivalent or appropriate programming statements or calls may be used consistent with the scope and spirit of the invention.

In one embodiment, this ASCII string may be provided in hexadecimal format by using the print command with an appropriate delimiter. For example, the printf(3) library routine, when called with the “%x” format specifier, converts the binary data into hexadecimal format.

Finally, the method passes the ASCII string to the requesting client (step 250). In one embodiment, the index number that identifies the encryption key may be converted into ASCII, along with the encrypted message digest and expiration timestamp, such that the index number is a part of the ASCII character string. In another embodiment, the index number of the encryption key may be kept separate from the converted value and communicated separately to the requesting client.

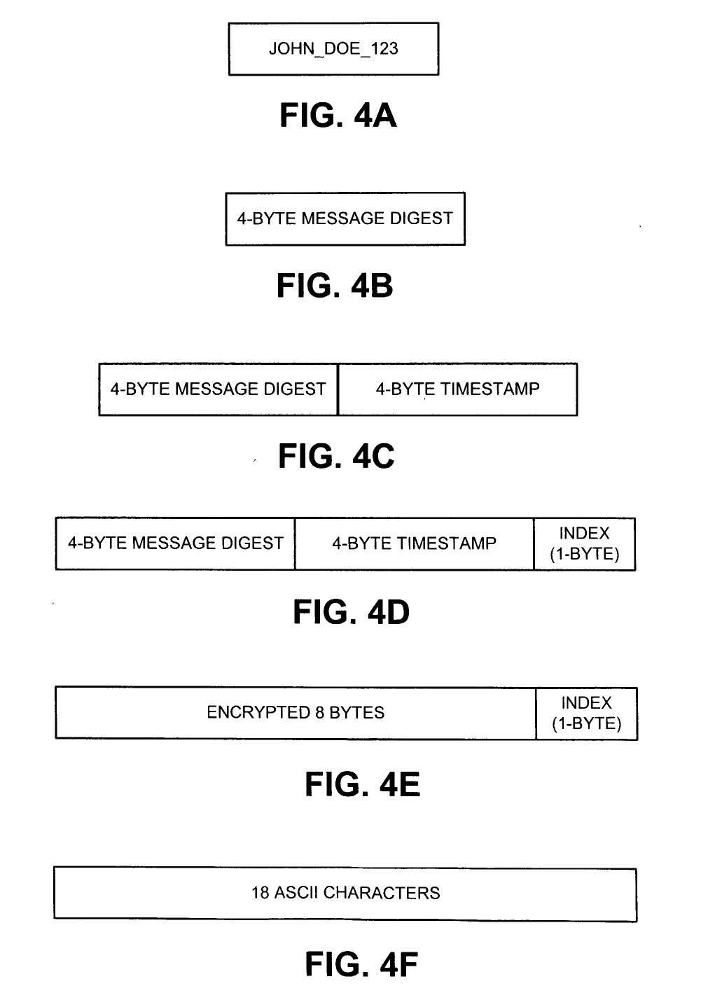

To illustrate the above-described method with an example, reference is made to FIGS. 4A-4F. Consider the session authentication ticket for a user name “John_Doe_{—}123” and password of “sleepydog,” with a session time out period of two hours. Once the user identification (John_Doe_{—}123) and password (sleepydog) have been received (FIG. 4A), the method computes a message digest or checksum of the user identification. In the illustrated embodiment this computed into a four-byte binary value (FIG. 4B). Then, the expiration timestamp is computed. Again, the timestamp is preferably computed in Epoch format, which is an integer indicating the number of seconds since Jan. 1, 1970. For a two-hour session, the value of 7,200 (60 seconds ×120 minutes) is added to the current time. This timestamp computation preferably results in a four-byte value, which is combined (e.g., concatenated) with the four-byte user ID value (FIG. 4C). Then, an index number is either generated (e.g., randomly) or otherwise selected for use in accessing an encryption key (FIG. 4D).

An encryption algorithm is utilized, using the encryption key that is retrieved based upon the index number, and the combined four-byte binary message digest and expiration timestamp are encrypted, resulting in an eight-byte encrypted value (see FIG. 4E). Note, however, that the index number is preferably retained (unencrypted), as this number is to be communicated to the requesting client. Finally, the nine binary bytes (the encrypted value and the index number) are converted into an ASCII string. In one embodiment, which is converted into a hexadecimal ASCII string, the result is eighteen characters of ASCII text (see FIG. 4F).

It should be appreciated from the foregoing discussion that, consistent with the invention, certain steps illustrated in FIG. 3 may be performed in differing order. For example, the index number may be generated or selected at any time before the encryption step.

Since the authentication ticket is well-formed, in that it contains no white spaces or reserved HTML characters, and is short enough to accommodate browser password limits, it may be passed to the requesting client and the password field of an FTP URL, which may be communicated in an HTML response (e.g., in the header of the response communicated from the Web server to the requesting client). As is known, an FTP URL has the format “FTP://user:password@hostname” therefore, in keeping with the forgoing example, the authentication ticket may be communicated to the client using the command “FTP://John_{—l Doe}_{—}123:ASCIIstring@www.hp.com,” where hp.com is the host domain, and “ASCIIstring” is the string of ASCII characters generated by the above-described method.

It should be appreciated that the above-described methodology has numerous advantages over prior approaches. One benefit relates to the relatively compact size of the ASCII string (only 18 bytes in the illustrated embodiment), while accommodating robust encryption. Indeed, the use/passage of cookies is not a viable option, because of the size of many cookies. As is known, cookies can be quite large (e.g., 2k bytes). However, the HTTP FTP URL specification does not allow for the accommodation of passwords near this large. Indeed, passwords of even 256 bytes are too large for the HTTP FTP URL string. In addition, cookies often use characters that are not supported or recognized by HTML.

As will be appreciated by persons skilled in the art, the destination ftp server specified in the ftp URL will preferably be modified to perform authentication by ascertaining that the message digest or checksum of the usemame (John_Doe_{—}123) matches the checksum or message digest which is encoded into the encrypted, encoded string ASCIIstring.

Once the authentication ticket has been communicated back to a user, the browser at the client's station may store this value in memory, or otherwise save it, until the user initiates another request of the Web site. At a later time, when the user initiates another request of the Web site, the browser running on the client workstation may incorporate information from this authentication ticket into a subsequent HTTP request of the Web site or host. Upon receiving this authentication ticket in an HTTP request, the host can decrypt the message to ascertain whether the session is still valid (i.e., has not yet timed-out) and that the message digest or checksum matches the checksum or message digest of the passed-in user ID. In this regard, it will be appreciated that, when a server generates a session authentication ticket and passes that ticket to a client workstation, the user ID is not passed along with the session authentication ticket. However, when a user subsequently accesses the Web server, the browser executing at the client workstation passes both the user identification and the character string from the previously-generated session authentication ticket to the Web server. Therefore, once the authentication ticket is decrypted, the embedded checksum of the user ID may be compared against a checksum of the passed-in user ID to verify/authorize the request.

Although not separately illustrated, it should be appreciated that the decryption process is simply the opposite of the encryption process that was illustrated in FIG. 3. That is, the ASCII string is converted to a binary value, which may be of the form of that illustrated in FIG. 4E. The eight-byte encrypted portion of this binary value is then decrypted using the index number to access the appropriate decryption key. In this regard, it will be appreciated that the various Web servers that comprise a Web site will each be installed with the same list of encryption keys, so that each has the ability to properly decrypt the message of FIG. 4E. That step results in a packet of information as illustrated in FIG. 4D, from which the timestamp and checksum of the user ID may be readily obtained.

Therefore, implementation of this embodiment of the present invention requires a one-time configuration step in which all sites or servers using this system will be installed with a consistent list of encryption keys. It will also be appreciated that the encryption can be quite robust or powerful (i.e. can use extremely long keys) without impacting the authentication mechanism, because the encryption key itself is never passed over the network. Accordingly, an extremely high degree of security can be obtained, even with a relatively small selection of encryption keys stored on the various Web servers.

For example, an encryption scheme might be chosen that uses a key length of 2048 bits, yielding 2²⁰⁴⁸ different keys. From this vast key space, 2⁸ keys (i.e., 256 keys) may be selected via some secret process. They may then be assigned index numbers. Since the only information transmitted over the network is the index number (and not the key itself), a would-be snoop has no way of knowing which of the 2²⁰⁴⁸ keys were selected. Therefore the would-be snoop has no alternative but to exhaustively try all 2²⁰⁴⁸ possible keys, which is a computationally infeasible task. Thus, the index scheme of the illustrated embodiment, while utilizing a mere 256 keys, still has the full security of a 2048-bit key space.

As will be described further herein, it will be appreciated that the broader concepts and teachings of the present invention may be implemented without imbedding a timestamp within the authentication ticket. In this regard, a similar method to that described above may be implemented, except that only the user identification is encrypted (i.e., there is no expiration timestamp to be encrypted with the user identification). Instead, timeout periods may be managed and handled in accordance with known methodologies. However, the inclusion of a timestamp within the encrypted message provides certain benefits, particularly in terms of security. In this regard, including a timestamp makes reverse engineering and decryption much more difficult, because the timestamp is a binary number that is never the same twice for a given session. Therefore, even though the user ID is constant throughout a session, the timestamp, which is combined with the user ID, is ever-changing. Therefore, the base information that is encrypted (i.e., the concatenation of the user ID and timestamp) is always different in each successive transmission. This would make interception and decryption by a snoop extremely difficult.

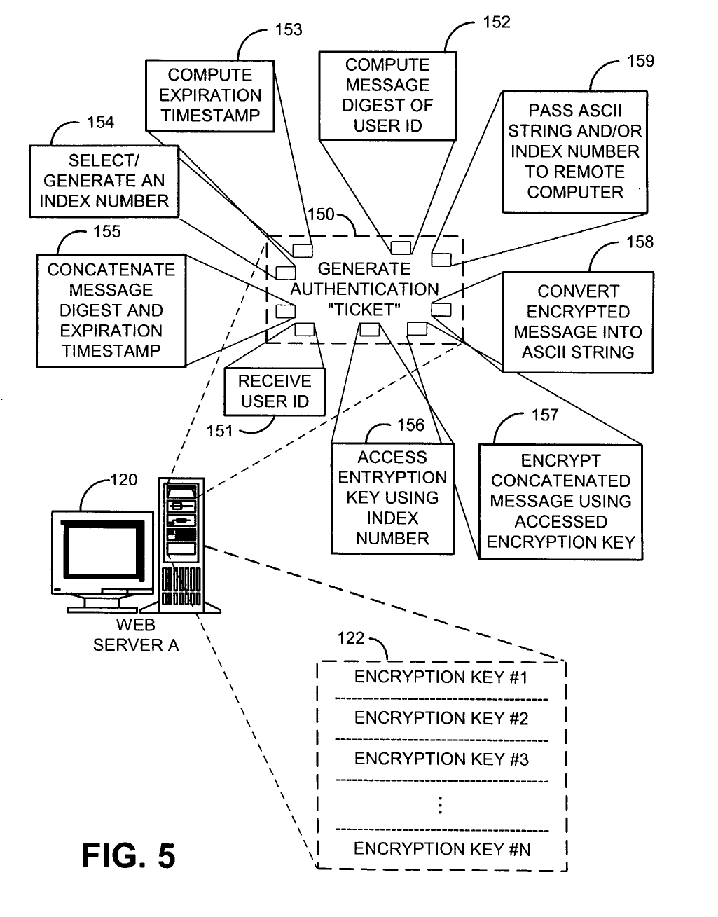

Having described the general operation of at least one embodiment of the present invention, reference is now made to FIG. 5, which illustrates certain system components that may be present in a server constructed in accordance with the above-described embodiments. In this regard, and as previously described, a Web server 120 may include logic 150 for generating an authentication ticket. This logic may, in turn, comprise a number of individual components. For example, one component 151 may be configured to receive the user ID (i.e., read the user ID from an HTTP request), another component 152 may be configured to compute a message digest or checksum of the user ID, while another component 153 may be configured to compute an expiration timestamp. Another component 154 may be configured to select or generate an index number that will be used to access an encryption key, while an additional component 155 may be configured to concatenate (or otherwise combine) the message digest or checksum and the expiration timestamp. Another component 156 may be provided to access an encryption key from a local memory 122 using the index number. Thus, an index number of “1” may access the first encryption key in the memory 122, while index number “42” may access the 42^{nd} encryption key stored in the memory 122.

Another component 157 maybe configured to encrypt the message using the accessed encryption key. In this regard, one embodiment may encrypt the combined message digest and expiration timestamp, while other embodiments may be configured merely to encrypt the message digest. Yet another component 158 may be configured to convert the encrypted message into an ASCII string.

As previously mentioned, this step may be performed by using a “printf(3)” subroutine call. Finally, a component may be configured to control the passage of the ASCII string to a remote computer. As previously mentioned, this may be done by embedding the ASCII string as a part of an FTP URL in an HTTP response. In addition and as previously discussed, the index number may be passed as a part of the ASCII string (e.g., converted along with the encrypted message by component 158), or may be separately passed to the remote computer. Of course, additional components and/or variants of the various logic blocks or components illustrated in FIG. 4 may be provided in a system constructed in accordance with the invention.

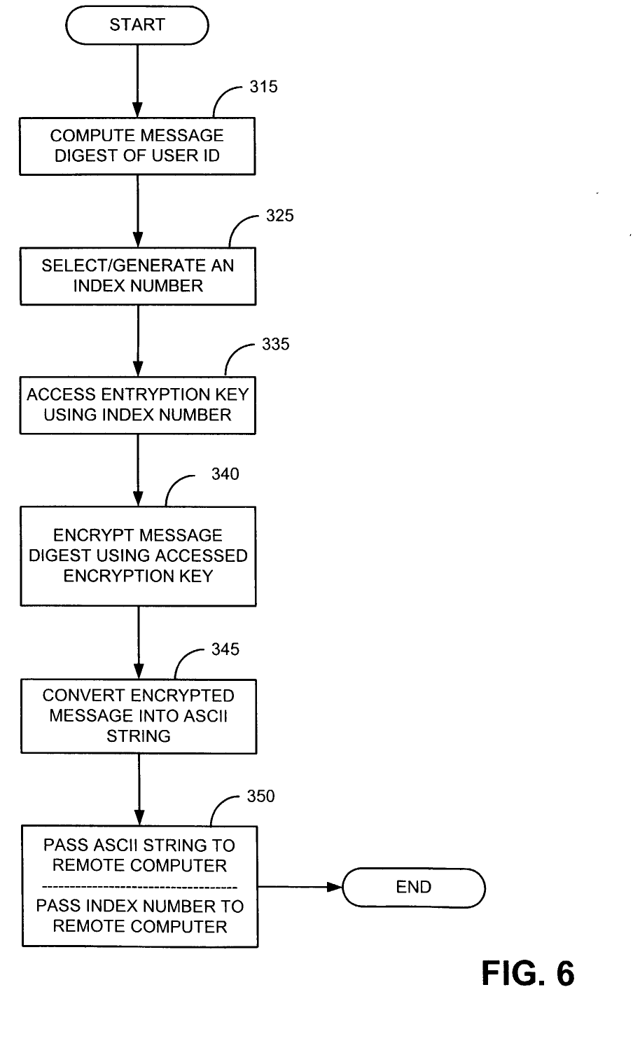

Having described one embodiment of the invention, reference is now made to FIG. 6 which is a flowchart illustrating a top-level methodology of an alternative embodiment of the present invention. In accordance with this embodiment, a method may compute a message digest of a user ID (step 315). Then, the message may select and/or generate an index number (step 325) to be used to access or retrieve an encryption key (step 335). Then, the message digest is encrypted using the accessed encryption key (step 340). Thereafter, the encrypted message is converted into an ASCII text string, in a manner similar to that described in connection with FIG. 3 (step 345). Finally, and like described in connection with FIG. 3, the ASCII string is passed to a remote computer (step 350).

Although not separately illustrated, a variant of the system illustrated in FIG. 5 may be provided for carrying out the method illustrated in FIG. 6.

It should be appreciated from the forgoing discussion that the present invention is not limited to the embodiments described above. Instead, the invention is readily extended and applicable to other embodiments and environments as well. For example, the session authentication process of the present invention may be employed in loosely-coupled Web sites. An example described above illustrated multiple servers of a single Web site. However, in some situations, it may be desirable to allow a session to extend across multiple Web sites (i.e., loosely-coupled Web sites). For example, consider a user who logs into a first Web site and begins a session in which the user begins to select components of a computer system that the user wishes to order. Assume further that the first few components (e.g., computer, monitor, keyboard) are all provided by the company of the host Web site that the user logged into. Through repeated HTTP requests/responses, the user may navigate through multiple servers at the first Web site in a manner described above. However, assume further that the user then selects a component, such as printer, which is not provided by the host Web site, but instead is provided by a company of an alternative, but loosely-coupled, Web site. The first Web site may then return a URL to the user, which redirects the user to the second Web site.

Using the authentication of the present invention, the user may transmit a request to the second, loosely-coupled Web site passing information from the authentication ticket to the second Web site, which may validate or verify the authentication ticket and allow the user to continue to the session at the second site. It should be appreciated that the methodology of the embodiment in such an environment, allows companies to form a common trusted bond (i.e., honoring the same authentication credentials, and eliminates the need for a common authentication database to be installed, eliminates the need for a mutual virtual private network to be configured, reduces the implementation time, and also reduces the security risk to each company's Web site by eliminating the need to configure cross firewalls.

In this embodiment, the session authentication may be passed using the following syntax: “http://secondsite.com/username=JohnDoe123/sid=ASCIIstring/”. The remote site may validate the user name/sid pair using a CGI-BIN script that implements an algorithm such as that described in connection with FIG. 3. Of course, the loosely-coupled Web site will have the same set of encryption keys available so that it can decrypt such re-directed requests.

A similar authentication methodology may be utilized in connection with certain electronic commerce transactions. For example, the authentication of a time-based service purchase, such as the purchase of two weeks of consulting time via the Web. In such an embodiment, upon receipt of a valid credit card number or other valid payment method, a customer may be issued a user ID and an authentication ticket. The authentication ticket may be calculated as described above in connection with FIG. 3, except that a two week expiration timestamp is encoded in the authentication ticket. Any time within the following two weeks, the customer may use that user ID and authorization ticket to login to a Web site and obtain the consulting services that were purchased. An advantage to the implementation of the invention in this type of environment is that no database needs to be maintained to keep track of who currently has a valid consulting purchase.

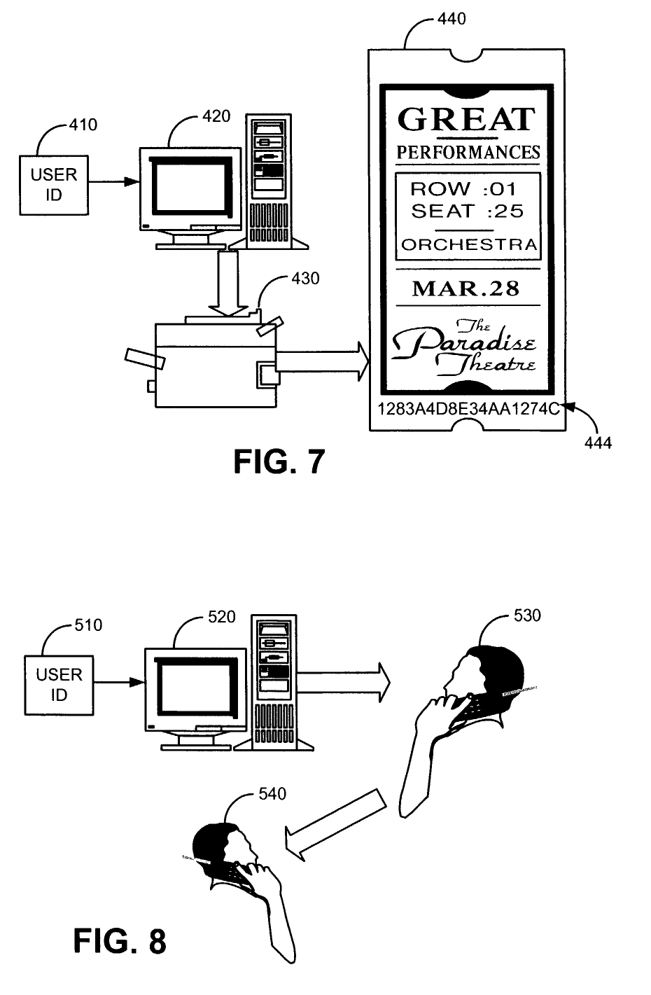

In yet another embodiment, an authentication ticket may be applied to an employee badge, airline ticket, concert ticket, or a variety of other physical indicia where authentication may be desired. In this regard, reference is made briefly to FIG. 7 which illustrates the application of the invention in the context of a orchestra ticket 440. During the purchase process, a user may supply a user ID 410 along with appropriate payment via the Web or other computer environment and receive the information for a printed ticket. This information may be delivered to the user's computer 420, which would print the ticket 440 on a printer 430. The ticket printed could contain an authentication number 444, which would contain the user's ID encrypted within that number 444. Such an embodiment allows a user to purchase a ticket over the Internet or by other means through a computer 420 and have the ticket immediately printed at the user's home. The user may then present this ticket 440 upon entrance to the event. At that time, the authentication number 444 may be scanned or physically keyed into a computer that would verify the user's ID. Of course, the user may be requested to present personal identification along with the ticket 440 to ensure that the personal ID matched the ID associated with the ticket 440. Although the row, date, and seat number are printed visibly on the ticket, in one embodiment that information may also be encoded into the encrypted authentication number 444.

A similar system and methodology may be implemented for purchasing airline tickets, or other event tickets. In addition, since the authentication ticket or token is so small (eighteen characters in the embodiment described herein) and contains only common hexadecimal characters, it would be feasible to simply read the authentication ticket over a telephone if necessary. In this regard, reference is made briefly to FIG. 8 in which a user ID 510 is input to a computer 520 which may in a certain application, visually display an authentication number for a user 530. The user may then simply speak this authentication number into a telephone to a remote person 540 for verification.

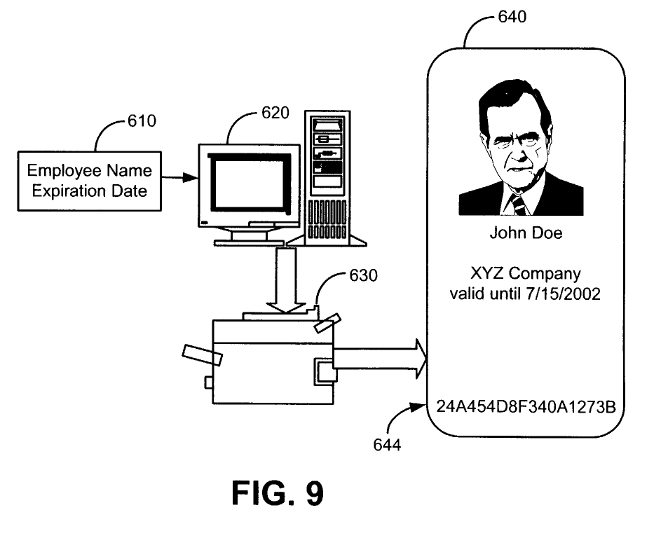

Reference is now made to FIG. 9, which is a diagram illustrating another embodiment of the invention, similar to the embodiment of FIG. 7. Specifically, this embodiment illustrates the use of the invention in an embodiment which processes or prints company/employee badges or IDs 640. In one implementation, and employee name (e.g., John Doe) and expiration date (Jul. 15, 2002) 410 may be supplied to a computer 620, which generates an electronic form of the badge or ID. This electronic badge or ID may be printed on a printer 630. As illustrated, the badge may include a photo of the employee, along with the employee name, company name, and expiration date, all in a visibly-readable form. The printed badge 640 may also include a printed version of the authentication number 644, which may contain the employee name, company name, and expiration date encrypted therein. More particularly, the computer 620 may concatenate the employee name, company name, and/or expiration date into one string, and generate a message digest for that string. The computer may then select an index number to use for retrieving an encryption key that is used to encrypt the message digest. From this information, the authentication number 644 may be generated as described above, in connection with the other embodiments.

Of course, the authentication number may be embedded on the badge in the form of a bar code, magnetic strip, or other form that is easily read by computerized means. That way, the employee could present the badge or ID to an appropriate “reader” (computer or person) at the time of entry, for authentication/validation. In this regard, the authentication would comprise the decrypting of the authentication number 644 to confirm that the information decrypted (e.g., employee name, company name, and/or expiration date) matched the information printed on the badge 644.

What is claimed is:

1. A method for authenticating a Web session comprising:
receiving a user ID;
computing a message digest of the user ID;
computing an expiration timestamp for the session;
selecting an index number;
combining the message digest and expiration timestamp;
accessing an encryption key using the index number;
encrypting the combined message using the accessed encryption key; and
converting the encrypted message into an ASCII string.

2. The method of claim 1, wherein the step of combining the message digest and expiration timestamp more specifically includes concatenating the message digest and expiration timestamp.

3. The method of claim 1, further comprises passing the ASCII string to a remote computer using an FTP (file transport protocol) URL (uniform resource locator) within an HTML (hyper-text markup language) page, the FTP URL being of the form ftp://ID:ASCII@hostname, wherein ID is the user ID and ASCII is the ASCII string.

4. The method of claim 1, wherein the step of receiving the user ID more specifically comprises receiving the user ID through an HTML (hyper-text markup language) page that is communicated from a remote client browser.

5. The method of claim 1, wherein the step of computing a message digest of the user ID more specifically comprises computing a four-byte binary value which is an encoded form of the user ID.

6. The method of claim 1, wherein the step of computing an expiration timestamp more specifically comprises computing an expiration timestamp in Epoch format.

7. The method of claim 1, wherein the step of selecting an index number more specifically comprises generating a random number within a predefined range of values.

8. The method of claim 1, wherein the step of accessing the encryption key more specifically comprises retrieving an encryption key from a storage segment containing a plurality of encryption keys, wherein the retrieved encryption key is obtained from a location or position within the storage segment based upon the index number.

9. The method of claim 1, wherein the step of encrypting the combined message more specifically comprises encrypting the combined message digest and timestamp into an eight-byte binary value.

10. The method of claim 1, further comprising the step of concatenating the index number to the encrypted message.

11. The method of claim 1, wherein the step of converting the encrypted message into an ASCII string more specifically comprises using a “printf” command.

12. The method of claim 1, wherein the step of converting the encrypted message into an ASCII string more specifically includes converting the encrypted message into a hexadecimal value.

13. The method of claim 10, wherein the step of converting the encrypted message into an ASCII string more specifically comprises converting the encrypted message and the index number into an ASCII string using a “printf” command.

14. The method of claim 3, further including the step of passing the index number to the remote computer.

15. The method of claim 14, wherein the step of passing the index number to the remote computer more specifically comprises passing the index number to the remote computer separate from the ASCII string.

16. The method of claim 14, wherein the step of converting the encrypted message into an ASCII string more specifically comprises converting a combination of the encrypted message and the index number into an ASCII string, wherein the index number is communicated to the remote computer as a part of the ASCII string.

17. A system for authenticating a transaction comprising:
logic configured to receive a user ID;
logic configured to compute a message digest of the user ID;
logic configured to select an index number;
logic configured to combine the message digest with expiration timestamp;
logic configured to select an encryption key from a plurality of encryption keys using the index number;
logic configured to encrypt the combined message using the selected encryption key; and
logic configured to convert the encrypted message into an ASCII string.

18. The system of claim 17, further including logic configured to generate an expiration timestamp.

19. The system of claim 17, further including logic configured to communicate the ASCII string to a remote computer.

20. The system of claim 17, further including a local memory for storing the plurality of encryption keys.

21. A method for authenticating a transaction comprising:
computing a message digest of a user ID;
selecting an index number;
selecting an encryption key from a plurality of encryption keys using the index number;
encrypting the message digest using the selected encryption key; and
converting the encrypted message into an ASCII string.

22. The method of claim 21, further comprising: concatenating the message digest with an expiration timestamp, wherein the step of encrypting the message more specifically includes encrypting the concatenated message using the accessed encryption key.

23. The method of claim 21, wherein the step of selecting the encryption key more specifically includes retrieving the encryption key from a local memory based on the index number.

24. The method of claim 21, further including the step of communicating the ASCII string to a remote computer.

25. The method of claim 21, further including the step of communicating the ASCII string to a person through voice communication.

26. The method of claim 21, further including the step of printing the ASCII string onto a ticket.

27. The method of claim 26, wherein the ticket is one selected from the group consisting of an airline ticket, a concert ticket, an employee ID card, and an event ticket.

28. The method of claim 26, wherein the step of printing the ASCII string onto a ticket more specifically includes printing the ASCII string onto the ticket in a form that it may be later electronically scanned for verification.
